(19) United States
(12) Patent Application Publication
(10) Pub. No.: US 2002/0093212 A1
(43) Pub. Date: Jul. 18, 2002

(54) Holding mechanism, in particular for a gripping apparatus

(75) Inventor: Rodiger Ostholt, Wetter (DE)

Correspondence Address: HENRY M FEIEREISEN, 350 FIFTH AVENUE, SUITE 3220, NEW YORK, NY, 10118, US

(73) Assignee: DEMAG CRANES & COMPONENTS GMBH

(21) Appl. No.: 10/091,907

(22) Filed: Mar. 6, 2002

Related U.S. Application Data
(63) Continuation-in-part of application No. 09/718,853, filed on Nov. 22, 2000.

(30) Foreign Application Priority Data
Nov. 29, 1999 (DE) 199 58 834
Mar. 9, 2001 (DE) 101 11 688

(51) Int. Cl. B25J 15/08

(52) U.S. Cl. 294/119.1

(57) ABSTRACT

A holding mechanism for retaining the position of a piston rod of a pneumatic cylinder forming part of a primary fluid-operated system, includes a first set of plates disposed in spaced-apart parallel relationship and having one end connected to the piston rod so as to move together with the piston rod in a longitudinal direction and a second set of plates for engagement between the plates of the first set so that the plates of the first and second sets bear laterally upon one another. A lever is urged in forced engagement against the plates by an elastic member, which is connected to the lever and biased by fluid from the pressure source. In the presence of a pressure drop, the elastic member squeezes the plates of the first and second sets, so as to secure the plates in position through friction.

### CROSS-REFERENCES TO RELATED APPLICATIONS

This application is a continuation-in-part of prior filed copending application application. Ser. No. 09/718,853, filed Nov. 22, 2000.

This application further claims the priority of German Patent Application Serial No. 101 11 688, filed Mar. 9, 2001, the subject matter of which is incorporated herein by reference.

### BACKGROUND OF THE INVENTION

The present invention relates, in general, to a holding mechanism, and more particularly to a holding mechanism for use in a gripping apparatus.

Pneumatically operated grippers, in particular tong-type grippers, include locking mechanisms with shut-off valves to secure a sufficient operating pressure for the gripper, when encountering a pressure drop. Also known are attached brakes for grippers with pneumatic cylinder to trigger a braking in the presence of a pressure drop and thereby prevent an opening of the gripper.

Common to all these approaches is the fact that the structural length of the pressure or pneumatic cylinder is significantly increased, and moreover, brakes cannot or only in a very complex way attached selectively to a pressure cylinder of, e.g., a gripper.

It would therefore be desirable and advantageous to provide an improved holding mechanism for piston rod and pneumatic cylinder units, which obviates prior art shortcomings and has a compact structure and which can easily be mounted to the pneumatic cylinder, without changing the structural length thereof.

### SUMMARY OF THE INVENTION

According to one aspect of the present invention, a holding mechanism for retaining the position of a piston rod of a pneumatic cylinder forming part of a primary fluid-operated system including a pressure source for supply of fluid to the pneumatic cylinder, includes a first set of plates disposed in spaced-apart parallel relationship and having one end connected to the piston rod so as to move together with the piston rod in a longitudinal direction; a second set of plates for engagement between the plates of the first set, whereby the plates of the first and second sets of plates bear laterally upon one another; a lever having a free end resting against a confronting one of the plates of the first and second sets; and a force-application unit for applying a force on the lever to urge the lever against the confronting one of the plates of the first and second sets, wherein the force-application unit includes an elastic member connected to the lever, and a secondary fluid-operated system, operated by fluid from the pressure source of the primary fluid-operated system, for biasing the elastic member, wherein the elastic member squeezes the plates of the first and second sets of plates in the presence of a pressure drop, so as to secure the plates in position through friction.

The present invention resolves prior art problems by providing meshing plates which are movable relative to one another during normal operation. One set of plates is secured to the pneumatic cylinder whereas the other set of plates is movable relative thereto and connected to the piston rod of the pneumatic cylinder. Only when a pressure drop is encountered are the plates urged into forced engagement for maintaining the plates in the respective position so that the piston rod and the pertaining gripper are held in the clamping position. In other words, the piston rod is prevented from moving relative to the pneumatic cylinder. The holding mechanism can be attached as a unit to the pneumatic cylinder. In view of the modular configuration and the varying number of plates and the pressure-applying force, a maximum holding force including a desired progression of the holding force can be established in a simple manner, so that the holding mechanism according to the present invention can easily be suited and matched to any type of gripper apparatus. The holding mechanism operates with low friction and is resistant to wear. Moreover no transverse forces are applied onto the piston rod by the holding mechanism according to the present invention and no added force introduction is effected into the device.

According to another feature of the present invention, the lever may be a swingable double-arm lever, and the elastic member is a spring mounted to one end of the lever and applying a spring force, wherein the secondary fluid-operated system applies a counterforce on another end of the lever commensurate with a pressure applied by the primary fluid-operated system so that the lever acts against one side of the plates of the first and second sets at a force which corresponds to a difference of the spring force and the counterforce.

According to another feature of the present invention, the secondary fluid-operated system may include a pneumatic auxiliary cylinder and a piston rod moveable in and out with respect to the pneumatic auxiliary cylinder, with the piston rod of the secondary fluid-operated system acting upon the other end of the lever.

According to another feature of the present invention, the double-arm lever may be configured as a triangular plate, with two neighboring corners defining the one end of the lever and the other end of the lever, and a third corner of the lever defining the free end which rests against the confronting one of the plates of the first and second sets. Suitably, the triangular plate is rotatable about its center to establish favorable lever conditions.

According to another feature of the present invention, the lever may be a pivot lever having a long lever arm and a short lever arm which terminates in the free end, wherein the elastic member is a spring having one end mounted to the pneumatic cylinder and another end operatively connected to the pneumatic auxiliary cylinder and one end of the long lever arm of the lever so as to urge the short lever arm of the lever to squeeze together the plates of the first and second sets in the presence of a pressure drop.

### BRIEF DESCRIPTION OF THE DRAWING

The above and other objects, features and advantages of the present invention will be more readily apparent upon reading the following description of a preferred exemplified embodiment of the invention with reference to the accompanying drawing, in which:

FIG. 1 is a three-dimensional illustration of a gripping apparatus for grasping a load, incorporating a holding mechanism in accordance with the present invention, whereby a housing portion of the gripping apparatus is broken away to show internal components;

FIG. 2 is a plan view of the gripping apparatus of FIG. 1, having a modified housing configuration and showing the arrangement of a primary fluid-operated system;

FIG. 3 is a vertical cross sectional view of the gripping apparatus, taken along the line III-III in FIG. 2;

FIG. 4 is a vertical cross sectional view of the gripping apparatus, taken along the line IV-IV in FIGS. 2 and 7;

FIG. 5 is a vertical cross sectional view of the gripping apparatus, taken along the line V-V in FIG. 6;

FIG. 6 is a plan view of the gripping apparatus of FIG. 1, showing the incorporation of a first variation of a holding mechanism according to the present invention;

FIG. 7 is a plan view of the gripping apparatus of FIG. 1, showing the arrangement of a synchronizing device;

FIG. 8 is a schematic illustration of a second variation of a holding mechanism according to the present invention for use in a gripping apparatus;

FIG. 9 is a schematic illustration of the holding apparatus of FIG. 8, without illustration of the sheet metal plates; and

FIG. 10 is a plan view of the holding mechanism.

### DETAILED DESCRIPTION OF PREFERRED EMBODIMENTS

Throughout all the Figures, same or corresponding elements are generally indicated by same reference numerals.

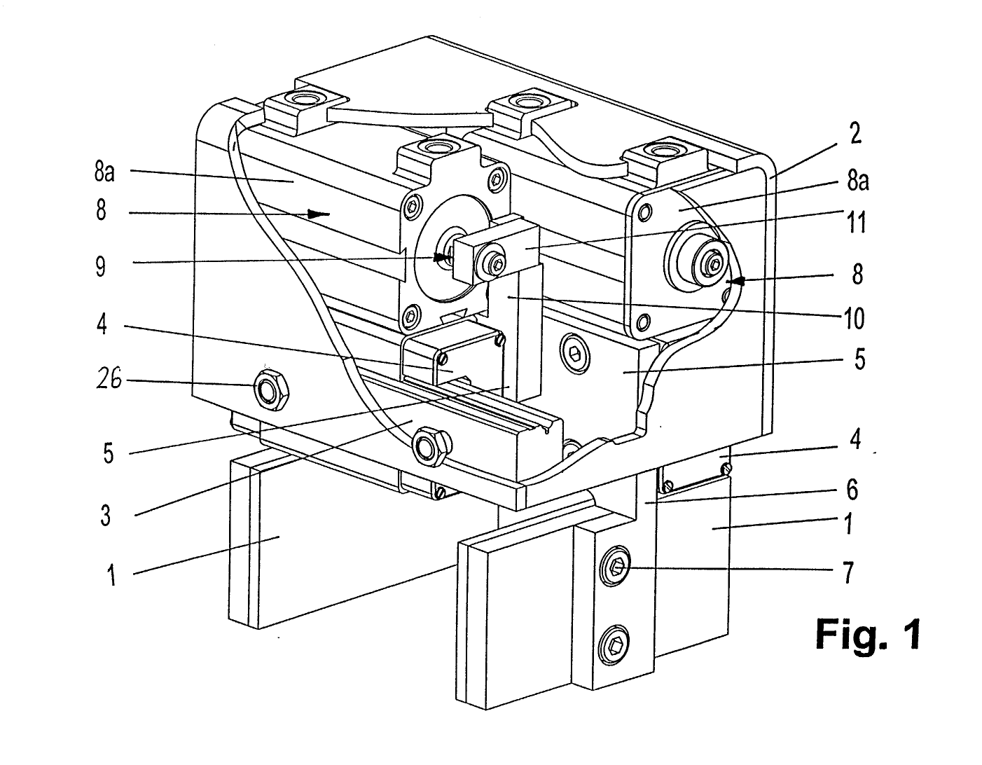

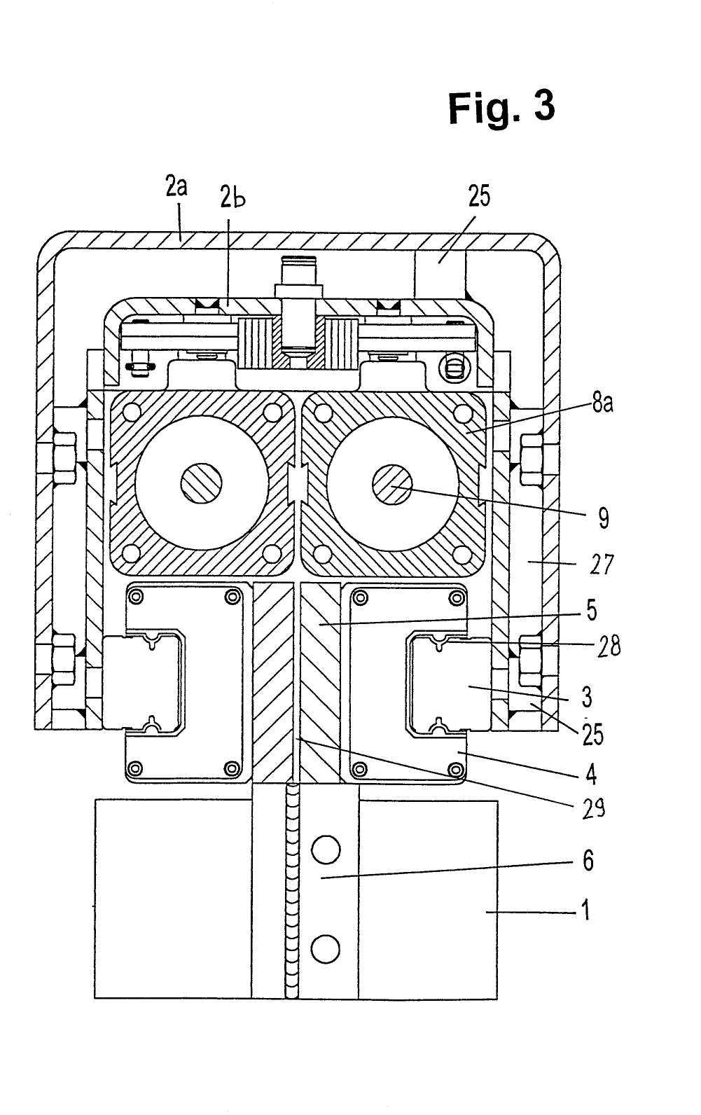

Turning now to the drawing, and in particular to FIG. 1, there is shown a three-dimensional illustration of a gripping apparatus for grasping a load in accordance with the present invention, including a housing 2 and two grippers 1 having confronting plate-shaped clamping jaws projecting out from underneath the housing 2. For ease of illustration, portions of the housing 2 are broken away in FIG. 1 to show internal components of the gripping apparatus. Fitted inside the housing 2 are two elongate beams 3 (only one is visible in the depiction of FIG. 1) which extend in a common plane in parallel relationship and are configured as profiled rails, as shown in particular in FIG. 3. The elongate beams 3 are fixed in place adjacent to the inside of two opposite sidewalls of the housing 2 by screw fasteners 26. Guided for displacement along each elongate beam 3 is a longitudinal carrier 5 which extends longitudinally in the direction of the elongate beam 3 and is secured to a runner 4 for support upon and displacement along the elongate beam 3. Both carriers 5 are laterally spaced from one another, when viewed in the direction of the elongate beams 3 and move relative to one another over a portion of the carrier length so that the carriers 5 overlap along a portion, when viewed from the side.

Formed to one of the ends of each of both carriers 5 is an attachment 6 which projects out from underneath the housing 2. The attachments 6 of the carriers 5 are respectively mounted by fastening screws 7 to the grippers 1 which are thus supported by the carriers 5.

Positioned above the elongate beams 3 is a primary fluid-operated system 8 in the form of two pneumatic cylinders 8a which are secured to sidewalls of the housing 2. Reciprocating in the pneumatic cylinders 8a are pistons, not shown, whose piston rods 9 are respectively connected to the carriers 5. The fluid-operated system 8 is so configured that the carriers 5 are moved in opposition to one another by the piston rods 9. Both pneumatic cylinders 8a extend above the elongate beams 3 in longitudinal direction thereof, with both piston rods 9 pointing in opposite directions. As a consequence of the disposition of both pneumatic cylinders 8a, FIG. 1 shows the front of the pneumatic cylinder 8a to the left in FIG. 1 and the rear of the pneumatic cylinder 8a to the right in FIG. 1.

Disposed on the other free end of each of the carriers 5, in opposition to the attachment 6, is a further attachment 10 which extends upwards to the associated pneumatic cylinder 8a. Each attachment 10 is securely fixed on one end to a corresponding one of the carriers 5 and on the other end to a corresponding one of the piston rods 9 via a bracket 11.

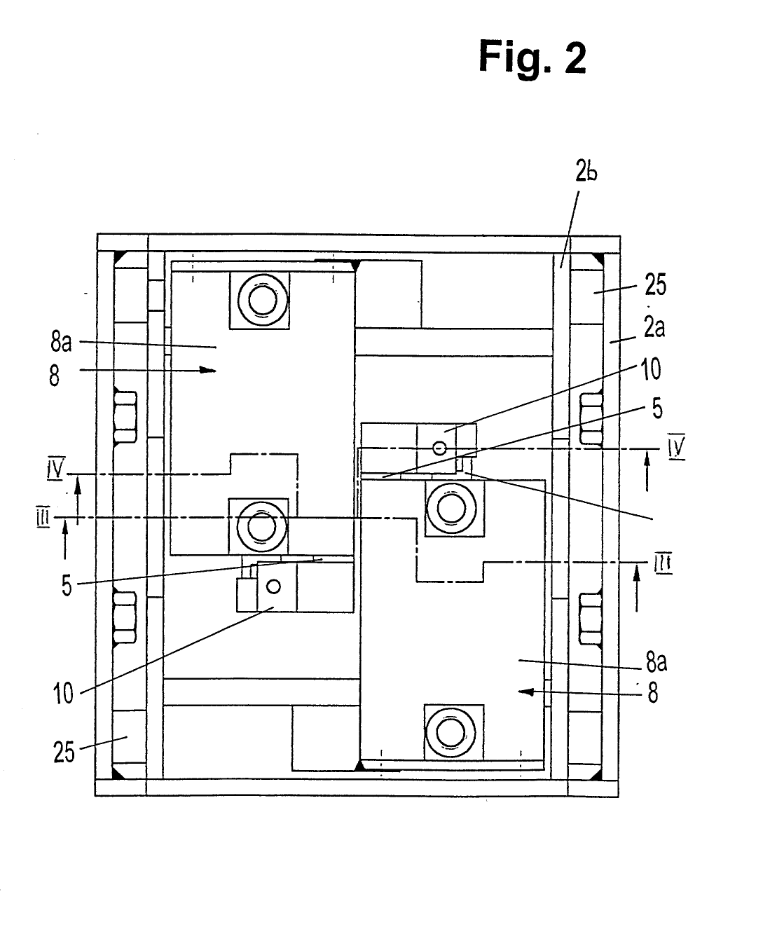

Turning now to FIG. 2, there is shown a plan view of the gripping apparatus of FIG. 1, showing the arrangement of the primary fluid-operated system 8 with the two pneumatic cylinders 8a. In contrast to the configuration of FIG. 1, the housing 2 is shown as being of double-walled construction on two opposite sides (the right-hand side and left-hand side in FIG. 2). As shown in particular in FIG. 3, which is a vertical cross sectional view of the gripping apparatus, taken along the line III-III in FIG. 2, the housing 2 is composed of two housing portions 2a, 2b which are open on one side and fitted within one another at formation of a gap-like free space 27. Received in the free space 27 are spacers 25 for interconnecting the housing portions 2a, 2b. The free space 27 also provides room for accommodating conduits (not shown) of the fluid-operated system 8 for conducting pneumatic fluid, e.g. air. Thus, the conduits are protected from external influence.

FIG. 3 also shows in more detail the configuration of the runners 4 which have a generally U-shaped form and substantially embrace the elongate beams 5, except for the side adjoining the housing part 2b. Circulating about an inner raceway of each of the runners 4 are balls which project into a complementary groove 28 of the elongate beams 3 and provide thereby a play-free support of the runners 4 upon the elongate beams 3. This type of support is also capable to absorb transverse forces and transverse moments. FIG. 3 further shows the formation of a small air gap 29 between the moving carriers 5.

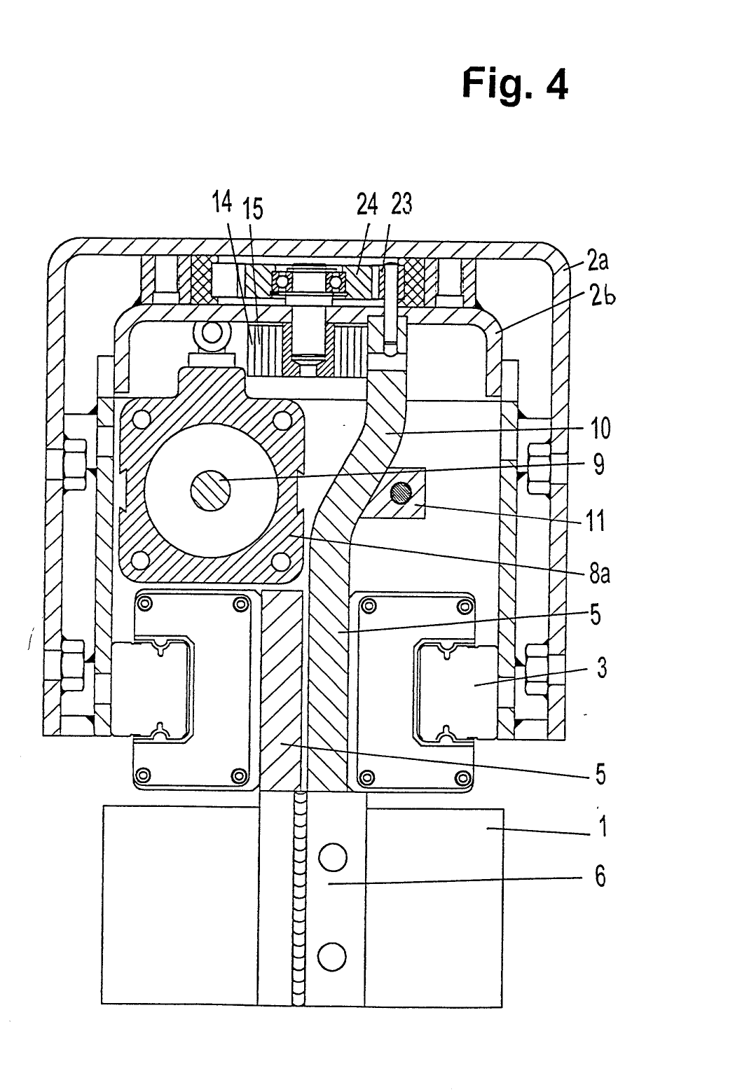

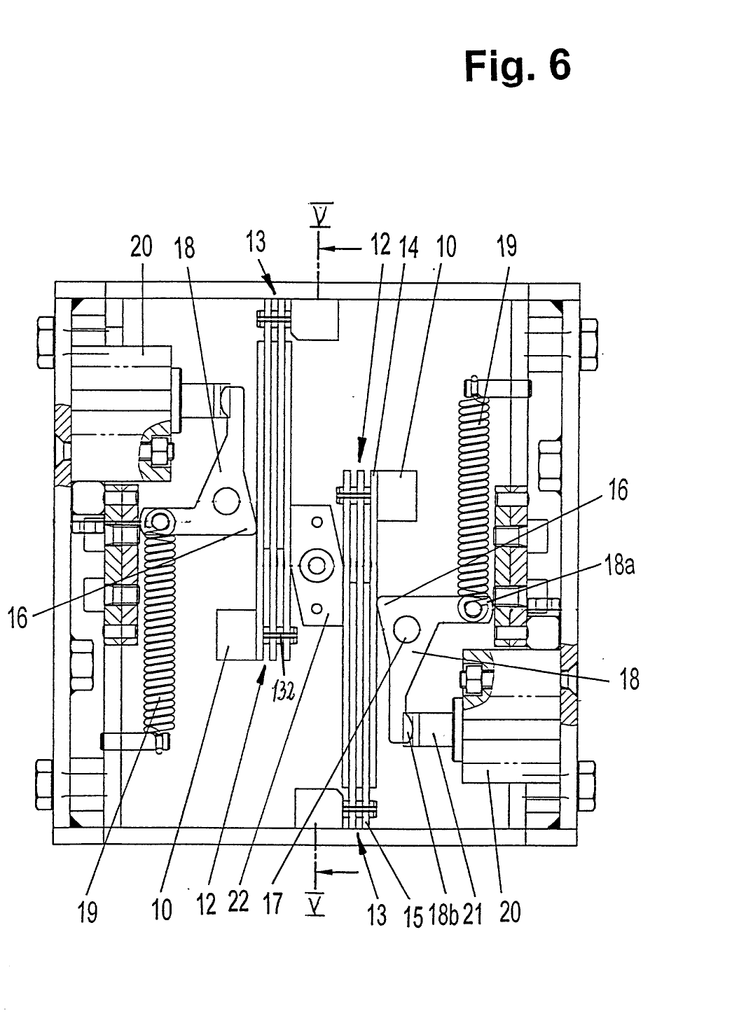

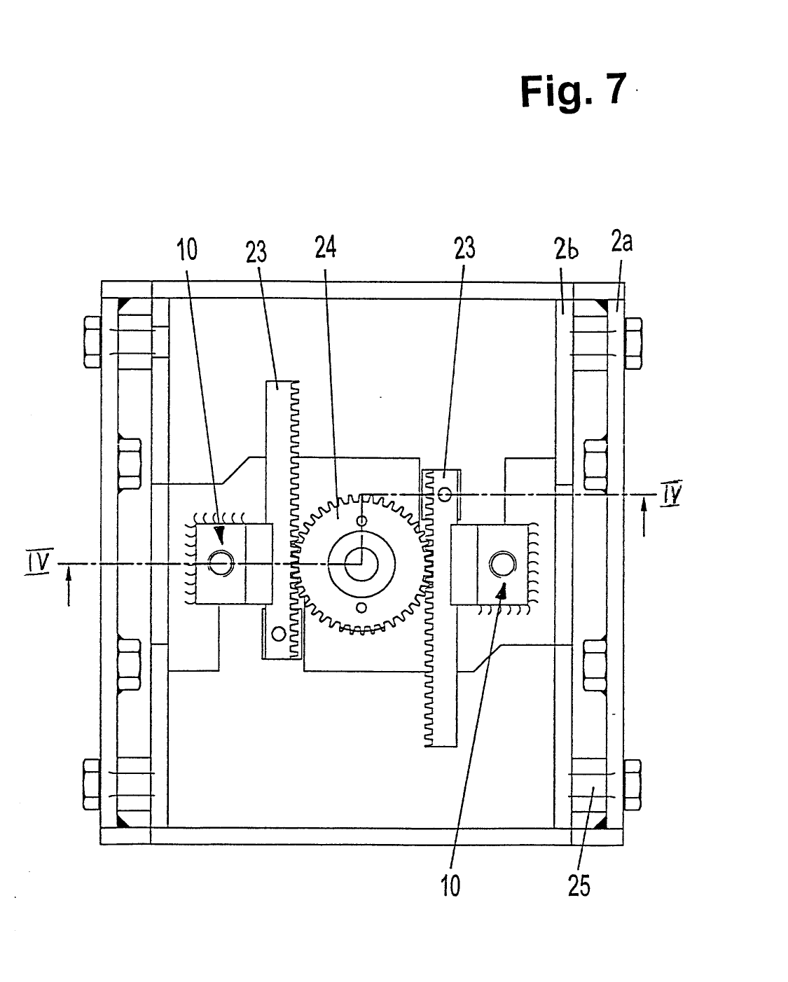

Referring now to FIG. 4, which is a vertical cross sectional view of the gripping apparatus, taken along the line IV-IV in FIG. 2, the incorporation of a holding mechanism for retaining the grippers in a load-clamping position, in the event of a pressure drop in the primary fluid-operated system 8, and a synchronizing device can be seen above the pneumatic cylinders 8a. For ease of illustration, the holding mechanism, which is shown in more detail in FIG. 6, and the synchronizing device, which is shown in more detail in FIG. 7, have been omitted from FIG. 2.

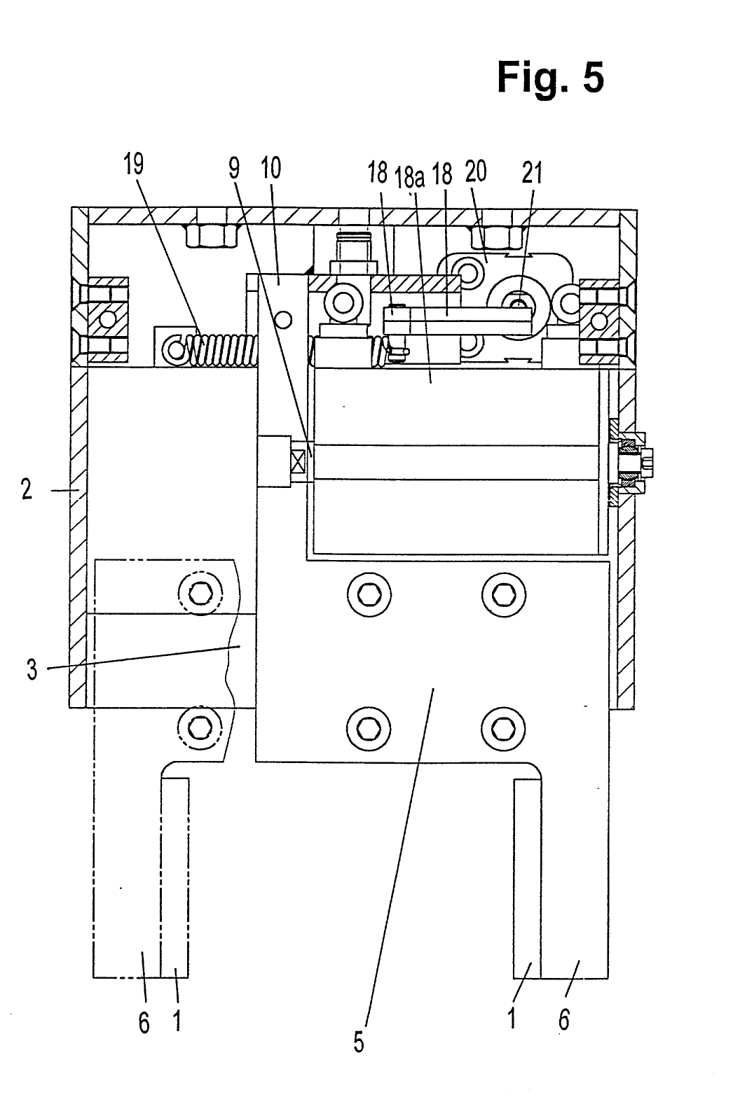

FIG. 5 shows the carriers 5 in a disposition in which they are completely moved apart, as viewed transversely to their longitudinal extension. The carrier 5 on the left side of FIG. 5 is also shown by dash-dot line for ease of understanding. FIG. 5 further shows that the gripper elements 2 are arranged on both outwardly located ends of the pair of carriers 5.

Turning now to FIG. 6, there is shown in more detail the configuration of the holding mechanism in the form of two multiple-plate assemblies, with each assembly including a first set 12 of flat sheet metal plates 14 spaced equally from one another in parallel relationship to the elongate beams 3 and securely fixed to a free end of a corresponding one of the second attachments 10 of the carriers 5, and a second set 13 of flat sheet metal plates 15 securely fixed to one end of the housing 2 in opposition to the attachment 10, whereby the plates 14, 15 engage one another so as to bear laterally upon each other and to move relative to one another in longitudinal direction. As shown in conjunction with FIG. 3, the plates 14, 15 of the two assemblies extend in parallel relationship to the piston rods 9 of the pneumatic cylinders 8.

Acting upon the plates 14, 15 on the outer side of the multiple-plate assemblies are adjusters 16 which are swingably supported in the housing 2 for rotation about an axle 17. Each adjuster 16 is part of a swingable double-arm lever 18 which has one end 18a acted upon by a spring force applied by a spring 19. Acting on the opposite end 1 8b of the double-arm lever 18 is a piston rod 21 which reciprocates in a pneumatic auxiliary cylinder 20 forming part of a secondary fluid-operated system. As a result, a counterforce is applied on the end 18b of the lever 18 in correspondence with the pressure applied by the pneumatic cylinder 8a of the primary fluid-operated system 8. The spring 18 is hereby tensed so that the adjuster 16 is prevented from pressing against the plates 14, 15, when a sufficient pneumatic pressure is generated by the primary fluid-operated system 8.

In neutral state of the double-arm lever 18, the spring force and the counterforce are in balance. Suitably, the pneumatic auxiliary cylinders 20 of the secondary fluid-operated system, and the pneumatic cylinders 8a of the secondary fluid-operated system 8 are supplied with pneumatic fluid, e.g. air, from a same pressure source. When the spring force and the counterforce are out of balance, the adjusters 16 press against the plates 14, 15 at a pressure that equals a difference between the spring force and counterforce, whereby the plates 14, 15 are suitably supported on the opposite side of the adjusters 16 by the housing 2 via an abutment 22. As a consequence, when encountering a pressure drop in the pneumatic cylinders 8a, the adjusters 16 so compress the plates 14, 15 as to compensate for the pressure drop in the primary fluid-operated system 8 to thereby maintain a sufficient clamping force of the grippers 1. A failure in the primary fluid-operated system 8 results therefore in a sufficient compressing of the grippers 1 so that the grasped load will not be released.

As further shown in FIG. 6, the double-arm lever 8 is configured as a substantially triangular plate (double plate), whereby two neighboring corners form the ends 18a, 18b of the double-arm lever 18, whereas the third rounded and lobed corner forms the adjuster 16. The plate is hereby rotatable, roughly, about its center point.

FIG. 7 illustrates in greater detail the synchronizing device which is positioned in the housing 2 above the holding mechanism, as shown in FIG. 4. The synchronizing device includes two racks 23 in parallel relationship, with the teeth of the racks 23 confronting one another. The racks 23 are respectively secured to the attachments 10 of the carriers 5 and thus move in unison with the grippers 1. To synchronize their longitudinal displacement in opposition to one another, both racks 23 are interconnected by a pinion 24 arranged between the racks 23 and in mesh with the teeth of the racks 23.

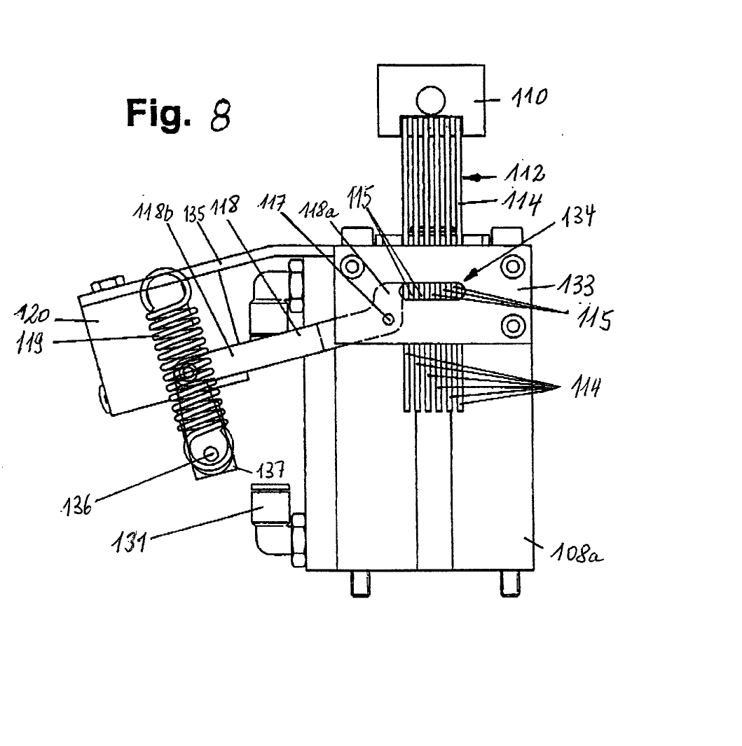

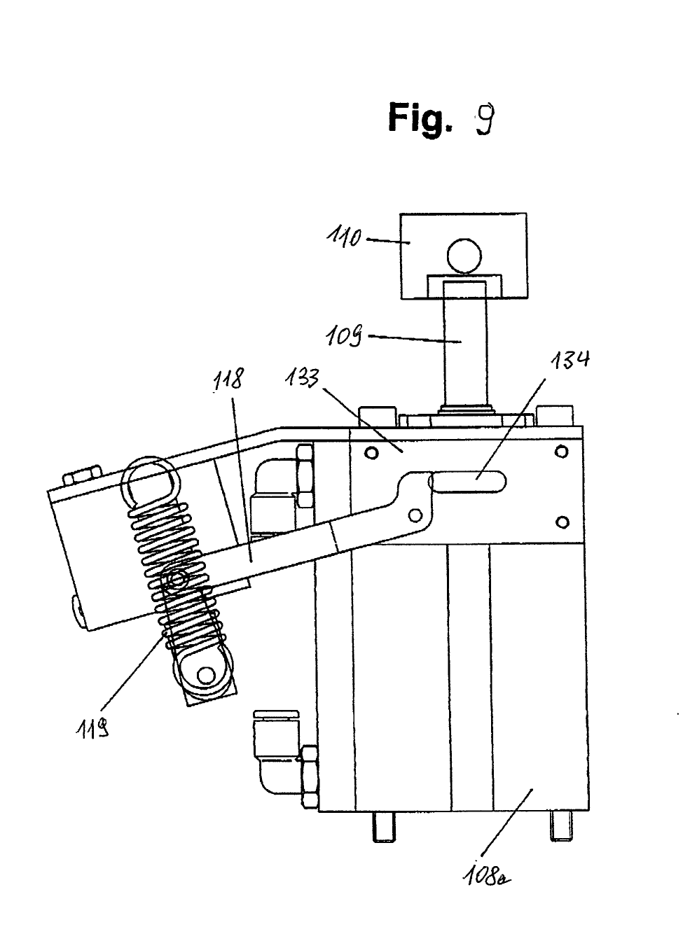

Turning now to FIGS. 8 and 9, there is shown a schematic illustration of a second variation of a holding mechanism according to the present invention for use in a gripping apparatus. In the following description, parts corresponding with those in FIG. 6 will be identified by corresponding reference numerals, each increased by “100”. The holding mechanism is mounted to a pressure cylinder 108a of a primary fluid-operated system for a gripping apparatus, e.g. a tong-type gripper, which is shown here only by way of an attachment (cross member) 110. Reciprocating in the pneumatic cylinder 108a is a piston 130 whose piston rod 109 extends out from the pressure cylinder 108a and is connected at its piston-distal end to the attachment 110. A fluid, e.g. air, is introduced under pressure from a pressure fluid reservoir, not shown, via an inlet conduit 131 into the pressure cylinder 108a to thereby move the piston 130 in the pressure cylinder 108a and thus the piston rod 109 in a desired manner for operating the gripper.

The holding mechanism includes a multiple-plate assembly which includes a first set 112 of flat sheet metal plates 114 spaced equally from one another in parallel relationship to the piston rod 109 to thereby define a gap between neighboring plates 114. The plates 114 have one end (upper end in FIG. 8) which is connected to the piston rod 109 via the attachment 110 by a pin 132 (shown by way of example in FIG. 6). Secured to opposite sides of the pressure cylinder 108a are cover plates 133 made of metal to prevent a movement of the plates 114 in a direction transversely to the piston rod 109 and provide a guide for the plates 114. FIG. 8 shows one of the cover plates 133 on one side of the pressure cylinder 108a and FIG. 9 shows the other one of the cover plates 133 on the other side of the pressure cylinder 108a, whereby the multiple-plate assembly has been omitted in FIG. 9 for ease of illustration.

The holding mechanism, shown in FIGS. 8 and 9 is a modular unit that can be attached atop a gripping apparatus in a position shown, e.g., in FIG. 6.

Placed in the gaps between the plates 114 are sheet metal plates 115 of a second set of the assembly, whereby the plates 114, 115 engage one another so as to bear flat laterally upon each other and to move relative to one another in longitudinal direction. The plates 115 are configured as small jaws having noses on opposite sides for engagement in respective oblong holes 134 of the cover plates 133, with the oblong holes 134 extending transversely to the piston rod 109. The plates 114 are secured in the oblong holes 134 in transverse direction thereto and guided in longitudinal direction of the oblong holes 1 07a for slight transverse mobility.

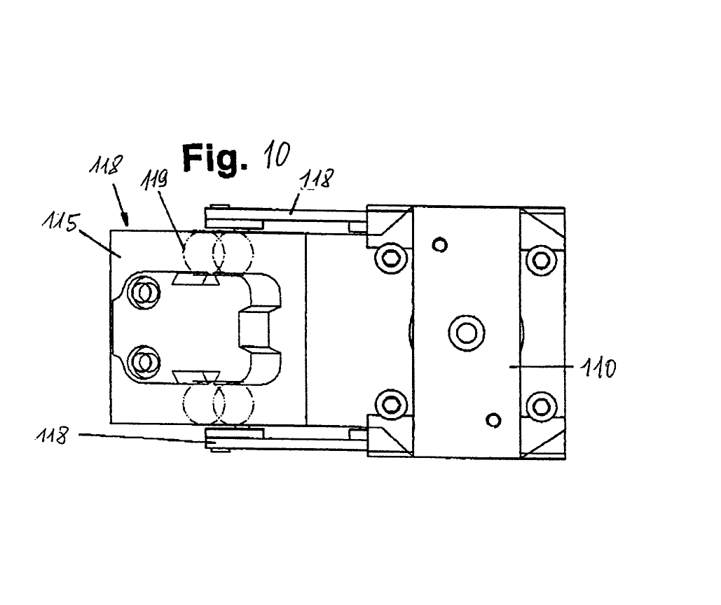

Acting upon the plates 114, 115 are pivot levers 118 (FIG. 10), each having a short lever arm 118a and a long lever arm 118bs and swingably supported to the pressure cylinder 108a for rotation about a pivot axis 117. The short lever arm 118a is urged into force engagement laterally against the outermost (left) plate 115 of the first set 112 of the multiple-plate assembly, so that the plates 114 and 115 are squeezed together by the pivot lever 118. In this way, the first set 112 of metal plates 114 and thus the piston rod 109 are fixed in the actual extended position.

The force engagement of the pivot lever 118 is implemented by an elastic element, e.g. a spring 119, having one end (upper end in FIG. 8) which is connected to an end face of the pressure cylinder 108a via an angle bracket 135. The other (lower) end of the spring 119 is supported via a pin 136 by a piston rod, not shown, which reciprocates in a pneumatic auxiliary cylinder 120 forming part of a secondary fluid-operated system and supplied with air under pressure from the same pressure fluid reservoir as the pressure cylinder 108a. The pin 136 is connected via a connecting element 137 with the long lever arm 118b of the pivot lever 118.

In the absence of air under pressure, the spring 119 forces the long lever arm 118b upward so that the plates 114, 115 are squeezed together by the short lever arm 118a. In the presence of sufficient air under pressure, the spring 119 is stretched (prestressed) by the piston rod of the auxiliary cylinder 120 so that the short lever arm 118a releases the plates 114, 115. When the piston rod 109 is in retracted position, the plates 114, 115 of the multiple-plate assembly and the auxiliary cylinder 120 extend at most over the entire length of the pressure cylinder 108a.

The holding mechanism, described herein, is a compact unit which can easily be mounted to a pressure cylinder 108a of a gripper and is especially suitable for use in emergency situations in which a pressure drop in the pressure fluid reservoir is encountered. In this case, the spring 119 forces the plates 114, 115 against one another to secure them in place through friction engagement so that the clamping position of the gripper elements of the gripper is maintained. Thus, a grabbed load is prevented from being dropped inadvertently.

While the invention has been illustrated and described as embodied in a holding mechanism, in particular for a gripping apparatus, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims:

What is claimed is:

1. A holding mechanism for retaining the position of a piston rod of a pneumatic cylinder forming part of a primary fluid-operated system including a pressure source for supply of fluid to the pneumatic cylinder, said holding mechanism comprising:
a first set of plates in spaced-apart parallel relationship, said plates having one end connected to the piston rod so as to move together with the piston rod in a longitudinal direction;
a second set of plates for engagement between the plates of the first set, whereby the plates of the first and second sets of plates bear laterally upon one another;
a lever having a free end resting against a confronting one of the plates of the first and second sets; and
a force-application unit for applying a force on the lever to urge the lever against the confronting one of the plates of the first and second sets, said force-application unit including an elastic member connected to the lever, and a secondary fluid-operated system, operated by fluid from the pressure source of the primary fluid-operated system, for biasing the elastic member, wherein the elastic member squeezes the plates of the first and second sets of plates in the presence of a pressure drop, so as to secure the plates in position through friction.

2. The holding mechanism of claim 1, wherein the lever is a swingable double-arm lever, and the elastic member is a spring mounted to one end of the lever and applying a spring force, wherein the secondary fluid-operated system applies a counterforce on another end of the lever commensurate with a pressure applied by the primary fluid-operated system so that the lever acts against one side of the plates of the first and second sets at a force which corresponds to a difference of the spring force and the counterforce.

3. The holding mechanism of claim 1, wherein the secondary fluid-operated system includes a pneumatic auxiliary cylinder and a piston rod moveable in and out with respect to the pneumatic auxiliary cylinder, said piston rod of the secondary fluid-operated system acting upon the other end of the lever.

4. The holding mechanism of claim 2, wherein the double-arm lever is configured as a triangular plate, with two neighboring corners defining the one end of the lever and the other end of the lever, and a third corner of the lever defining the free end which rests against the confronting one of the plates of the first and second sets.

5. The holding mechanism of claim 4, wherein the triangular plate defines a center and is rotatable about the center.

6. The holding mechanism of claim 1, wherein the first and second sets of plates are disposed on one side of the pneumatic cylinder, and further comprising a second pair of said first and second sets of plates disposed on another side of the pneumatic cylinder.

7. The holding mechanism of claim 1, wherein the lever is a pivot lever having a long lever arm and a short lever arm which terminates in the free end, wherein the elastic member is a spring having one end mounted to the pneumatic cylinder and another end operatively connected to the pneumatic auxiliary cylinder and one end of the long lever arm of the lever so as to urge the short lever arm of the lever to squeeze together the plates of the first and second sets in the presence of a pressure drop.

8. The holding mechanism of claim 1, and further comprising two cover plates mounted on opposite sides of the pneumatic cylinder and having each an oblong hole, wherein the plates of the second set are configured as short jaws having noses for engagement in the oblong holes of the cover plates.

9. A holding mechanism for retaining a clamping force of a gripping apparatus in the presence of a pressure drop in a primary fluid-operated system for operating the gripping apparatus, said holding mechanism comprising a multiple-plate assembly which includes a stationary first set of plates spaced equally from one another in parallel relationship; a second set of plates movable relative to the first set of plates and positioned in spaces between the first set of plates so that the plates of the first and second sets of plates bear laterally upon one another, and a force-application unit for squeezing together the plates of the first and second sets of plates, when encountering a pressure drop in the primary fluid-operated system.

10. The holding mechanism of claim 9, wherein the force-application unit includes a swingable double-arm lever having three attack points, with a first one of the attack points bearing against an outermost confronting plate of the multiple-plate assembly, a spring mounted to a second one of the attack points for applying a spring force, and a secondary fluid-operated system for applying a counterforce a third one of the attack points commensurate with a pressure applied by the primary fluid-operated system so that the first attack point acts against the multiple-plate assembly at a force which corresponds to a difference of the spring force and the counterforce.

11. The holding mechanism of claim 9, wherein the primary and the secondary fluid-operated systems are supplied with fluid from a common pressure source.

12. The holding mechanism of claim 10, wherein the double-arm lever is configured as a triangular plate.

13. The holding mechanism of claim 12, wherein the triangular plate defines a center and is rotatable about the center.

14. The holding mechanism of claim 9, wherein the force-application unit includes a pivot lever having a long lever arm and a short lever arm, and a spring connected to one end of the long lever arm and so constructed as to pull the long lever arm in the presence of a pressure drop to thereby urge the short lever arm against the plates of the first and second sets.
